(19) United States
(12) Patent Application Publication
(10) Pub. No.: US 2008/0179858 A1
(43) Pub. Date: Jul. 31, 2008

(54) Bicycle including a bicycle frame capable of concealing a battery cartridge

(76) Inventor: Wayne Chen, Kaohsiung City (TW)

Correspondence Address: HARNESS, DICKEY & PIERCE, P.L.C., P.O. BOX 8910, RESTON, VA, 20195, US

(21) Appl. No.: 11/700,059

(22) Filed: Jan. 31, 2007

(51) Int. Cl. B62K 3/02

(52) U.S. Cl. 280/281.1

(57) ABSTRACT

A bicycle includes a bicycle frame and a battery cartridge. The bicycle frame includes a head tube, and a steerer that extends through the head tube. The battery cartridge may be disposed removably in the steerer or between the head tube and the steerer to thereby conceal the battery cartridge for aesthetic purposes.

### BACKGROUND OF THE INVENTION

1. Field of the Invention

This invention relates to a bicycle, more particularly to a bicycle that includes a bicycle frame capable of concealing a battery cartridge.

2. Description of the Related Art

FIG. 1 illustrates a conventional bicycle 1 that includes a bicycle frame 11, a headlight 12, and a battery cartridge 13. The headlight 12 is mounted on a head tube of the bicycle frame 11. The battery cartridge 13 receives a battery unit (not shown) therein, is mounted on a seat tube of the bicycle frame 11, and is coupled electrically to the headlight 12, thereby permitting the battery unit to supply power to the headlight 12.

The conventional bicycle 1 is disadvantageous in that, since the battery cartridge 13 is exposed, the aesthetical aspect of the conventional bicycle 1 is undesirably compromised.

### SUMMARY OF THE INVENTION

Therefore, the object of the present invention is to provide a bicycle that can overcome the aforesaid drawback of the prior art.

According to the present invention, a bicycle comprises a bicycle frame and a battery cartridge. The bicycle frame includes a head tube. At least a portion of the battery cartridge is disposed in the head tube of the bicycle frame.

### BRIEF DESCRIPTION OF THE DRAWINGS

Other features and advantages of the present invention will become apparent in the following detailed description of the preferred embodiments with reference to the accompanying drawings, of which:

FIG. 1 is a schematic view of a conventional bicycle;

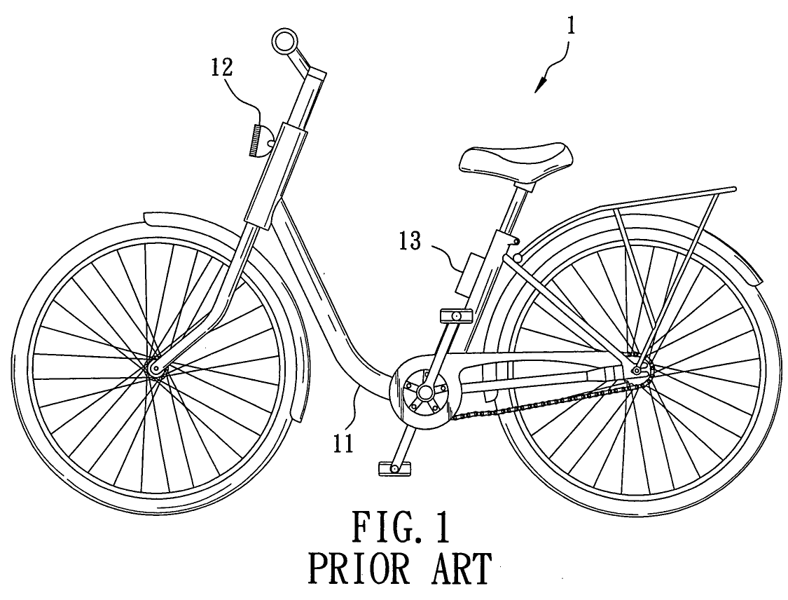

FIG. 2 is a fragmentary, partly exploded perspective view of the first preferred embodiment of a bicycle according to the present invention;

FIG. 3 is a fragmentary sectional view to illustrate a battery cartridge disposed in a steerer of a bicycle frame of the first preferred embodiment;

FIG. 4 is a fragmentary perspective view to illustrate a retainer that retains the battery cartridge in the steerer of the first preferred embodiment;

FIG. 5 is a fragmentary sectional view of the second preferred embodiment of a bicycle according to the present invention; and

FIG. 6 is a fragmentary sectional view of the third preferred embodiment of a bicycle according to the present invention.

### DETAILED DESCRIPTION OF THE PREFERRED EMBODIMENTS

Before the present invention is described in greater detail, it should be noted that like elements are denoted by the same reference numerals throughout the disclosure.

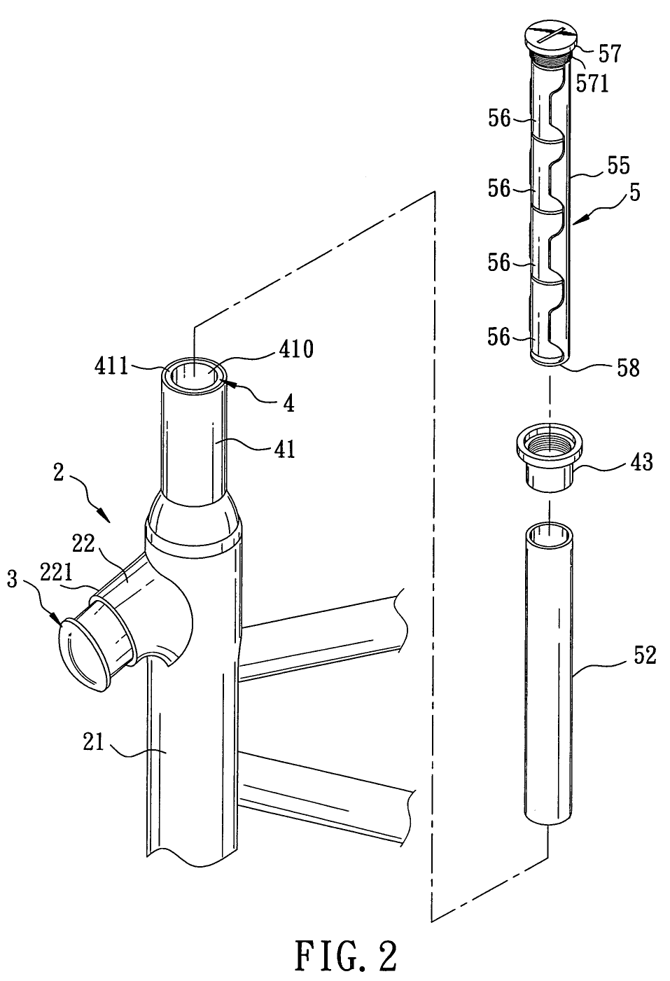

Referring to FIG. 2, the first preferred embodiment of a bicycle according to this invention is shown to include a bicycle frame 2 and a battery cartridge 5.

The bicycle frame 2 includes a head tube 21 and a bicycle fork 4. The bicycle fork 4 includes a steerer 41 that extends through and that is coupled rotatably to the head tube 21, in a manner well known in the art.

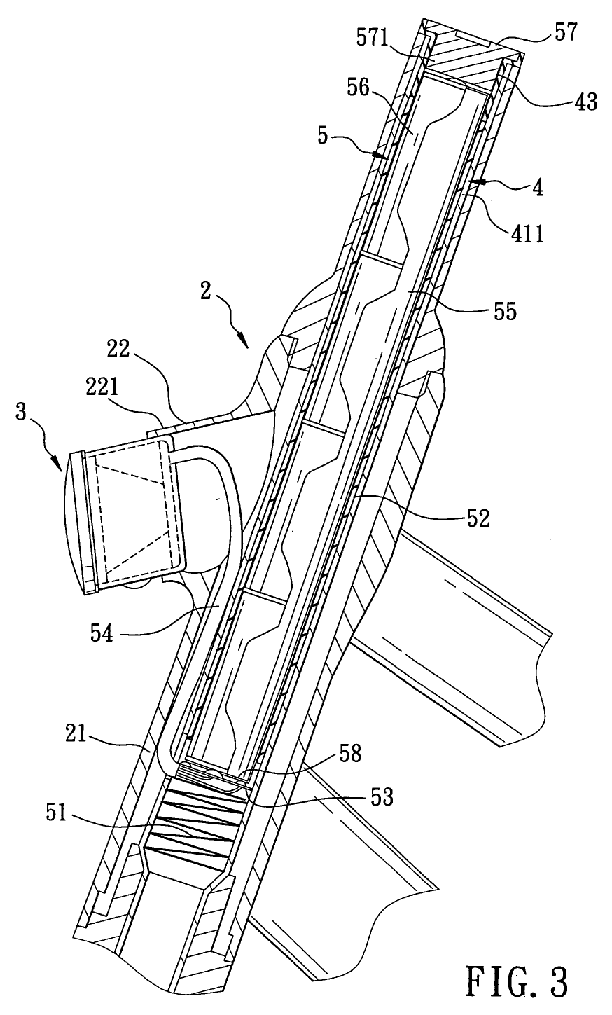

In this embodiment, the battery cartridge 5 is disposed removably in the steerer 41. With further reference to FIG. 3, the battery cartridge 5 includes a casing 55 that receives a battery unit 56 therein, and a first electrical contact unit 58 that is mounted on the casing 55, and that is connected electrically to the battery unit 56 when the battery unit 56 is received in the casing 55 of the battery cartridge 5.

The bicycle further includes a retainer 57 for retaining the battery cartridge 5 in the steerer 41. In particular, the steerer 41 has an open end 411 that defines an opening 410. The retainer 57 has an end portion 571 that extends into the steerer 41 through the opening 410 in the steerer 41, that abuts against the casing 55 of the battery cartridge 5 when the battery cartridge 5 is disposed in the steerer 41, and that is fastened releasably to the open end 411 of the steerer 41.

The bicycle further includes a threaded tube 43 that extends into the steerer 41 through the opening 410 in the steerer 41, that is secured to the open end 411 of the steerer 41, and that is provided with an inner thread. The retainer 57 is provided with an outer thread that engages the inner thread of the threaded tube 43 to thereby fasten releasably the retainer 57 to the open end 411 of the steerer 41.

The bicycle further includes a biasing member 51 that is disposed in the steerer 41, that abuts against the casing 55 of the battery cartridge 5 when the battery cartridge 5 is disposed in the steerer 41, and that biases the casing 55 of the battery cartridge 5 to extend out of the steerer 41 through the opening 410 in the steerer 41. In this embodiment, the biasing member 51 is a compression spring.

The bicycle further includes a second electrical contact unit 53, an electrical device 3, and an insulated wire unit 54.

The second electrical contact unit 53 is disposed in the steerer 41, is mounted on the biasing member 51, and is connected electrically to the first electrical contact unit 58 when the battery cartridge 5 is disposed in the steerer 41.

The electrical device 3, which is a headlight in this embodiment, is mounted on the head tube 21 of the bicycle frame 2. In particular, the bicycle frame 2 further includes a mounting tube 22 that extends from the head tube 21 and that has an open end 221. The electrical device 3 extends into and is secured on the open end 221 of the mounting tube 22.

The insulated wire unit 54 has a first end portion that extends into the steerer 41 and that is connected electrically to the second electrical contact unit 53, and a second end portion that extends through the head tube 21 and into the mounting tube 22 and that is connected electrically to the electrical device 3, thereby permitting the battery unit 56 in the battery cartridge 5 to supply power to the electrical device 3.

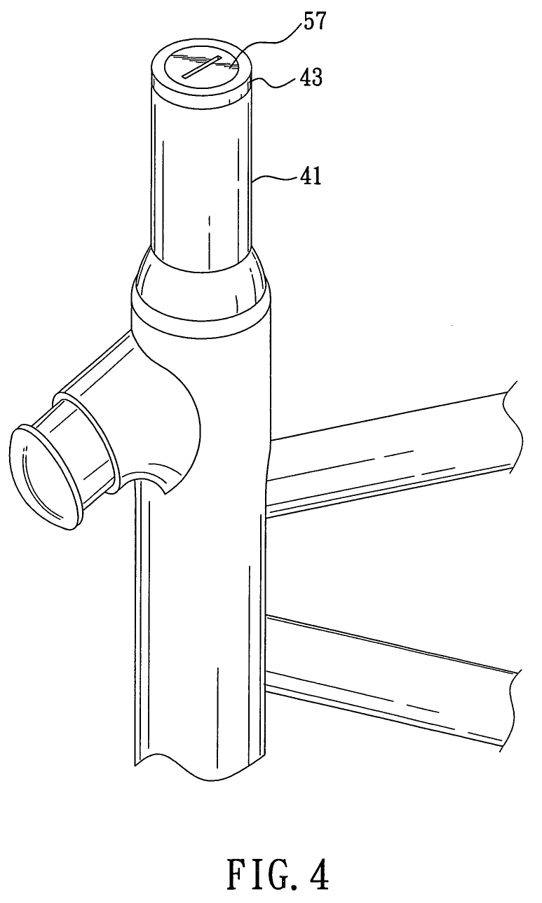

When it is desired to install the battery cartridge 5 to the bicycle of the present invention, the battery cartridge 5 is first inserted into the steerer 41 through the opening 410 in the steerer 41 such that the first electrical contact unit 58 of the battery cartridge 5 is in contact with the second electrical contact unit 53. The casing 55 of the battery cartridge 5 is then pushed, with the use of the retainer 57, against biasing action of the biasing member 51 into the steerer 41. Thereafter, the retainer 57 is engaged to the threaded tube 43 to thereby completely conceal the battery cartridge 5, as best shown in FIG. 4.

When it is desired to replace the battery unit 56 in the casing 55 of the battery cartridge 5, the retainer 57 is first disengaged from the threaded tube 43. At this time, the casing 55 of the battery cartridge 5 extends out of the steerer 41 through the opening 410 in the steerer 41 by virtue of the biasing action of the biasing member 51. The battery cartridge 5 is then removed from the steerer 41. Once the battery unit 56 is replaced, the battery cartridge 5 is installed in the steerer 41 by performing the aforementioned procedure.

It is noted that, in this embodiment, the battery cartridge 5 further includes a protective tube 52 that is sleeved on the casing 55 thereof.

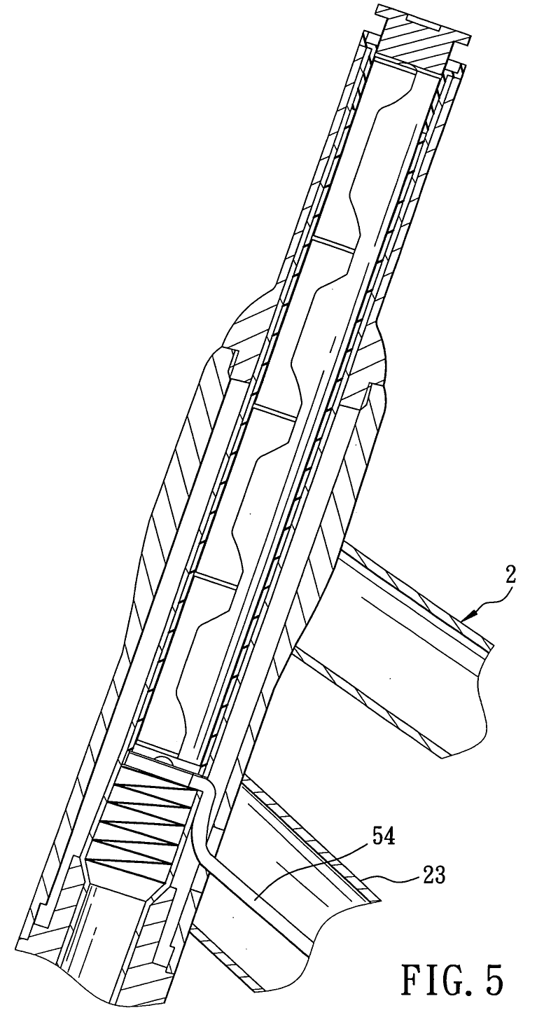

FIG. 5 illustrates the second preferred embodiment of a bicycle according to this invention. When compared with the previous embodiment, the electrical device 3 is a taillight that is mounted on a seat post (not shown) of the bicycle frame 2. The bicycle frame 2 further includes a down tube 23 through which the second end portion of the insulated wire unit 54 extends so as to connect electrically with the taillight.

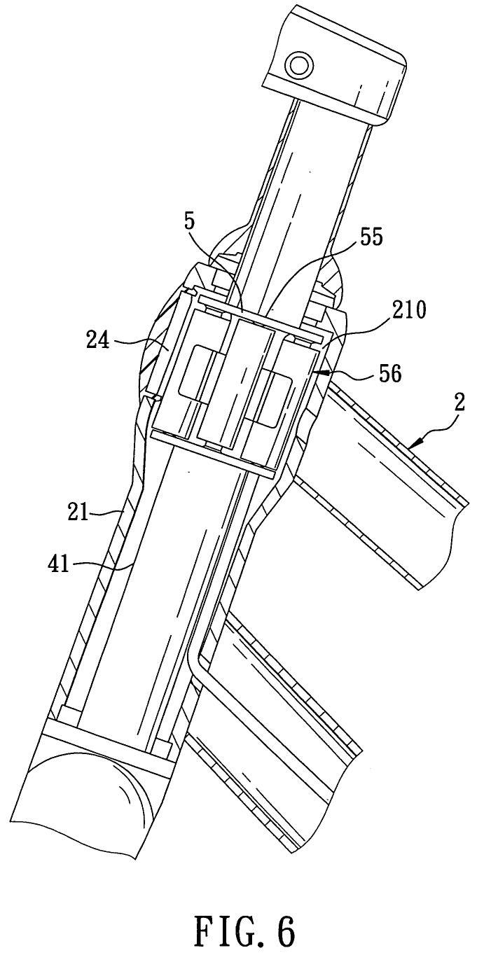

FIG. 6 illustrates the third preferred embodiment of a bicycle according to this invention. When compared with the previous embodiments, the casing 55 of the battery cartridge 5 is disposed between the head tube 21 and the steerer 41. In this embodiment, the casing 55 of the battery cartridge 5 is tubular and is sleeved rotatably on the steerer 41. The head tube 21 is formed with an access hole 210 for permitting access to the battery cartridge 5. The bicycle frame 2 further includes a lid 24 that is connected detachably to the head tube 21 so as to cover the access hole 210 in the head tube 21.

When it is desired to replace the battery unit 56 in the casing 55 of the battery cartridge 5, the lid 24 is first detached from the head tube 21 to thereby uncover the access hole 210 in the head tube 21. The casing 55 of the battery cartridge 5 is then rotated relative to the steerer 41 such that the battery unit 56 is registered with the access hole 210 in the head tube 21.

While the present invention has been described in connection with what are considered the most practical and preferred embodiments, it is understood that this invention is not limited to the disclosed embodiments but is intended to cover various arrangements included within the spirit and scope of the broadest interpretation so as to encompass all such modifications and equivalent arrangements.

What is claimed is:

1. A bicycle, comprising:
a bicycle frame including a head tube; and
a battery cartridge, at least a portion of which is disposed in said head tube of said bicycle frame.

2. The bicycle as claimed in claim 1, wherein said bicycle frame further includes a steerer that extends through and that is coupled rotatably to said head tube, said battery cartridge being disposed removably in said steerer.

3. The bicycle as claimed in claim 2, wherein said steerer has an open end that defines an opening, said bicycle further comprising a retainer for retaining said battery cartridge in said steerer.

4. The bicycle as claimed in claim 3, wherein said retainer extends into said steerer through said opening in said steerer, abuts against said battery cartridge when said battery cartridge is disposed in said steerer, and is fastened releasably to said open end of said steerer.

5. The bicycle as claimed in claim 4, further comprising a threaded tube extending into said steerer through said opening in said steerer, secured to said open end of said steerer, and provided with an inner thread, said retainer being provided with an outer thread that engages said inner thread of said threaded tube to thereby fasten releasably said retainer to said open end of said steerer.

6. The bicycle as claimed in claim 3, further comprising a biasing member disposed in said steerer, abutting against said battery cartridge when said battery cartridge is disposed in said steerer, and biasing said battery cartridge to extend out of said steerer through said opening in said steerer.

7. The bicycle as claimed in claim 2, wherein said battery cartridge includes a casing adapted to receive a battery unit therein, and a first electrical contact unit mounted on said casing and adapted to connect electrically to the battery unit, said bicycle further comprising:
a second electrical contact unit disposed in said steerer, and connected electrically to said first electrical contact unit when said battery cartridge is disposed in said steerer; and
an insulated wire unit having a first end portion that is connected electrically to said second electrical contact unit.

8. The bicycle as claimed in claim 7, further comprising an electrical device mounted on said bicycle frame, said insulated wire unit further having a second end portion that is connected electrically to said electrical device.

9. The bicycle as claimed in claim 8, wherein said bicycle frame further includes a mounting tube that extends from said head tube and that has an open end, said electrical device extending into and being secured on said open end of said mounting tube, said first end portion of said insulated wire unit extending into said steerer, said second end portion of said insulated wire unit extending through said head tube and into said mounting tube.

10. The bicycle as claimed in claim 1, wherein said head tube is formed with an access hole for permitting access to said battery cartridge therein.

11. The bicycle as claimed in claim 10, wherein said bicycle frame further includes a steerer that extends through and that is coupled rotatably to said head tube, said battery cartridge being disposed between said head tube and said steerer.

12. The bicycle as claimed in claim 11, wherein said battery cartridge is tubular, and is sleeved rotatably on said steerer when said battery cartridge is disposed in said head tube.

13. The bicycle as claimed in claim 10, wherein said bicycle frame further includes a lid for covering said access hole in said head tube.
